(19) United States
(12) Patent Application Publication
(10) Pub. No.: US 2011/0012871 A1
(43) Pub. Date: Jan. 20, 2011

(54) STYLUS

(75) Inventors: XI-MING WANG, Shenzhen City (CN); LEI HUANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/610,500

(22) Filed: Nov. 2, 2009

(30) Foreign Application Priority Data
Jul. 14, 2009 (CN) 200910304343.6

(51) Int. Cl. G06F 3/033

(52) U.S. Cl. 345/179

(57) ABSTRACT

A stylus is provided. The stylus comprises a stylus body, a pointed portion, and solvent-type adhesive. The stylus body comprises a main section and a head portion protruding from one end of the main section. The head portion defines cutouts and notches. The pointed portion defines a connecting groove. The connecting groove receives the head portion. Solvent-type adhesive fills up the cutouts and notches so as to adhere the head portion to the pointed portion.

### BACKGROUND

1. Technical Field

The present disclosure relates to styluses, particularly, to a stylus applied to a portable electronic device.

2. Description of Related Art

At present, portable electronic devices, such as mobile phones, hand-held computers, laptop computers, and personal digital assistants (PDAs), have become increasingly popular. Many of these portable electronic devices include an electronic stylus or pen, which can be utilized by a user for inputting and/or navigating user interface of the software application.

Currently, a typical stylus includes a stylus body and a pointed portion. The stylus body includes a plurality of latching blocks. The pointed portion defines a plurality of latching holes. The latching blocks are latched in the latching holes, such that the pointed portion is secured to the stylus body.

However, after repeated use, latching blocks and the latching holes cannot latch together stably and securely, resulting in shakiness of the stylus.

Therefore, there is room for improvement within the art.

### BRIEF DESCRIPTION OF THE DRAWINGS

Many aspects of the stylus can be better understood with reference to the following drawings. These drawings are not necessarily drawn to scale, the emphasis instead being placed upon clearly illustrating the principles of the present stylus. Moreover, in the drawings like reference numerals designate corresponding sections throughout the several views.

FIG. 1 is an assembled, isometric view of a stylus, in accordance with an exemplary embodiment.

FIG. 2 is a partially enlarged view of area II shown in FIG. 1.

FIG. 3 is an assembled, isometric view of a stylus shown in FIG. 1.

FIG. 4 is a cross-sectional view of a stylus taken along line IV-IV shown in FIG. 1.

FIG. 5 is similar to FIG. 4, but showing the head portion partially received in the connecting groove.

### DETAILED DESCRIPTION

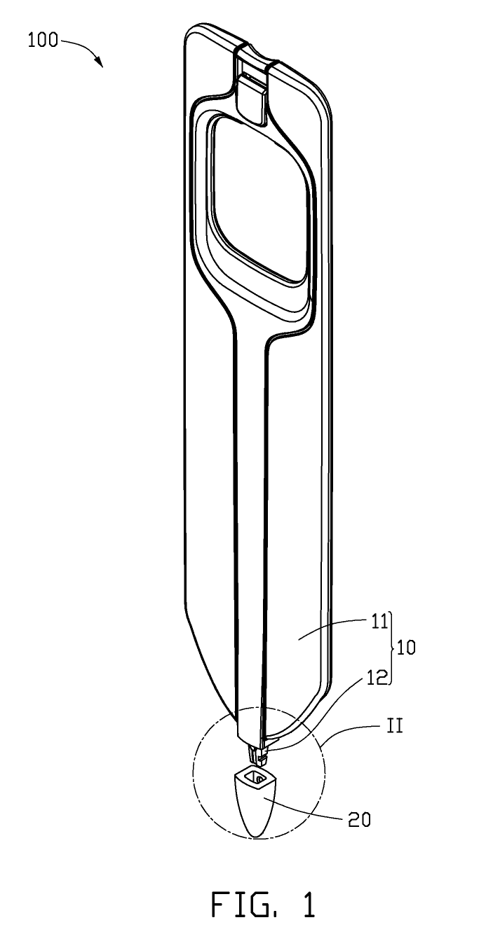

FIG. 1 shows an exemplary stylus. The stylus 100 is fit for use in portable electronic device, e.g., mobile phone and personal digital assistant (PDA). The stylus 100 includes a stylus body 10 and a pointed portion 20 connected to one end of the stylus body 10.

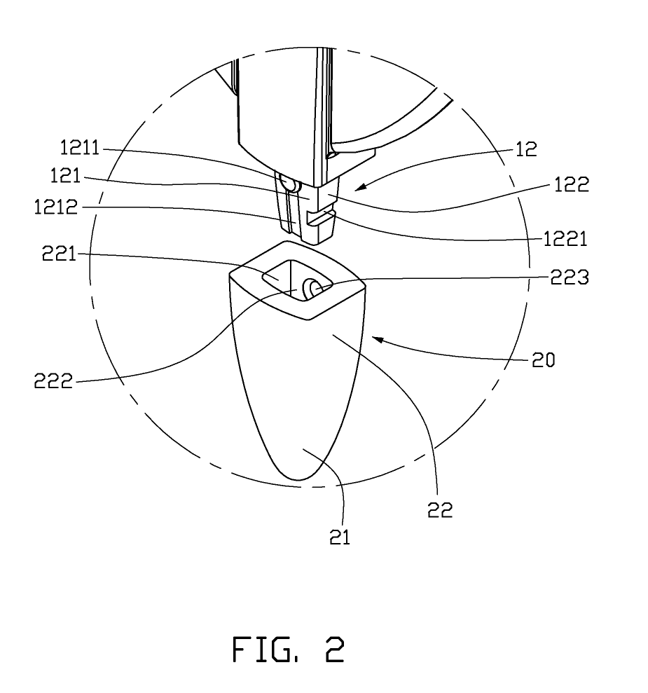

Referring to FIGS. 1 and 2 together, the stylus body 10 includes a main section 11 and a head portion 12 protruding from one end of the main section 11. The head portion 12 can be a rectangular bar, used to connect with the pointed portion 20. The head portion 12 may include two opposite first walls 121 and two opposite second walls 122. A latching block 1211 protrudes from each first wall 121, adjacent to the main section 11. The latching blocks 1211 are used to latch with the main section 11. Each first wall 121 defines a longitudinal cutout 1212. Each second wall 122 defines a transverse notch 1221. In this embodiment, the latching blocks 1211 are disposed in the cutouts 1212. The cutouts 1212 and the notch 1221 are configured for containing solvent-type adhesive 40, e.g., 3M2665. The solvent-type adhesive 40 has a good flow property to fill up the cutout 1212 and notch 1221 so as to adhere the head portion 12 to the pointed portion 20.

The pointed portion 20 includes a tip end 21 and a connecting end 22 opposite to the tip end 21. The tip end 21 is approximately taper-shaped and made of wear-resistant rubber, such as polyoxymethylene. The connecting portion 22 can be rectangular shaped for connecting with the head portion 12. A connecting groove 221 is defined in an end wall of the connecting portion 22, facing the head portion 12. Two opposite sidewalls 222 surround the connecting groove 221. A latching hole 223 is defined in each sidewall 222, communicating with the connecting groove 221. The latching blocks 122 are latched in the latching holes 223. The connecting groove 221 receives the head portion 12.

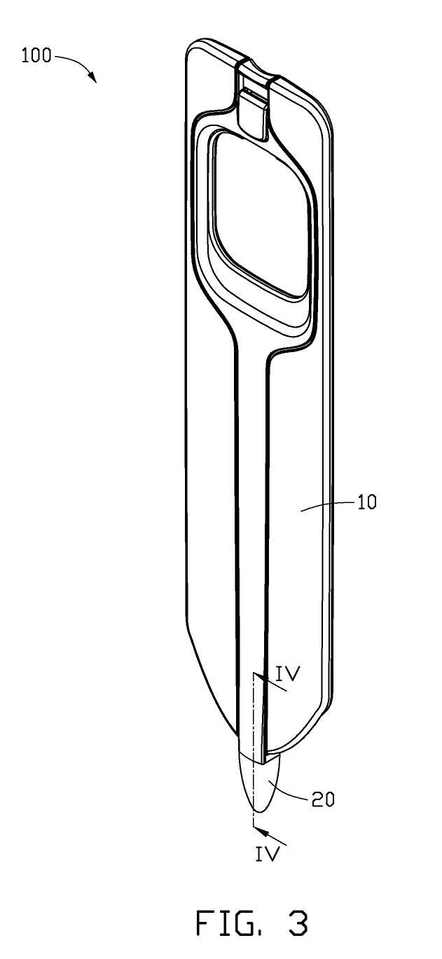

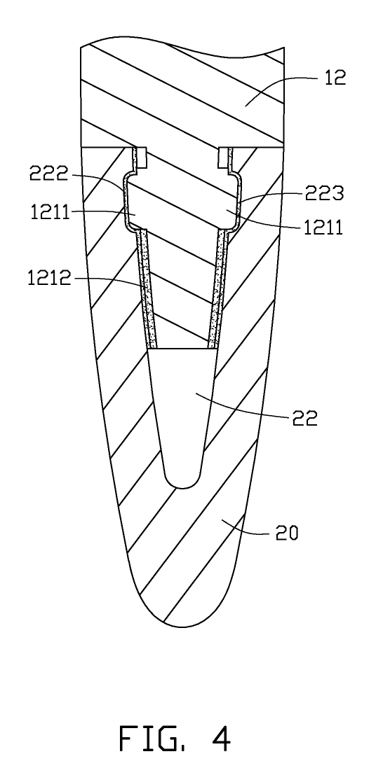

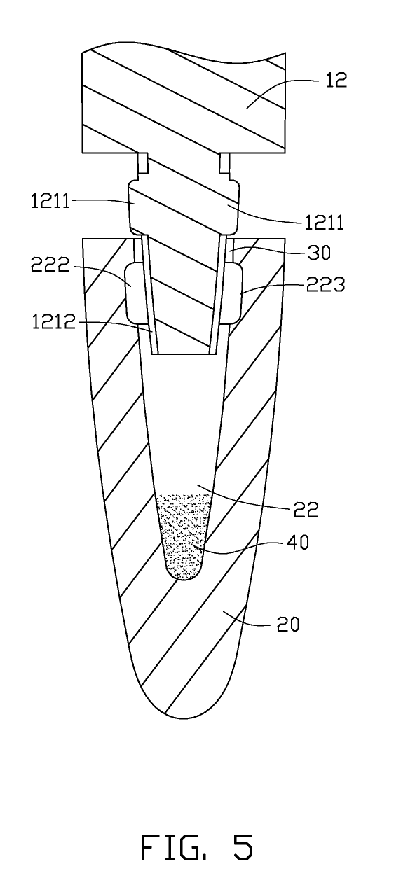

Referring to FIG. 3 to FIG. 5, in assembly, the head portion 12 is partially inserted into the connecting groove 221, thus an aperture 30 (referring to FIG. 5) between the head portion 12 and the pointed portion 20 is formed. Adhesive 40 is filled into the aperture 30. The head portion 12 is further inserted into the connecting groove 221 until the head portion 12 is completely received in the connecting groove 221. At this time, the latching blocks 1211 is latched into the latching holes 223 and the solvent-type adhesive 40 fills up the cutouts 1212 and notches 1221, and stably and securely adheres the head portion 12 and the pointed portion 20 together.

The present stylus 100 defines the cutouts 1212 and notches 1221 to receive solvent-type adhesive 40, thus the solvent-type adhesive 40 stably and securely combines the head portion 12 and the pointed portion 20 together. Furthermore, the solvent-type adhesive 40 can cushion concussion between the head portion 12 and the pointed portion 20 when the stylus 100 is dropped.

In alternative embodiment, the number of cutouts 1212 and the notches 1221 can vary according to requirements.

In another alternative embodiment, the head portion 12 can protrude from the pointed portion 20, correspondingly, the stylus body 10 defines the connecting groove 221. The head portion 12 is received in the connecting groove 221.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A stylus comprising:
a stylus body comprising a main section and a head portion protruding from one end of the main section, the head portion defining cutouts and notches;
a pointed portion defining a connecting groove, the connecting groove receiving the head portion; and
solvent-type adhesive filling up the cutouts and notches to adhere the head portion to the pointed portion.

2. The stylus as claimed in claim 1, wherein the head portion includes two opposite first walls and two opposite second walls, each first wall defines one of the cutouts in longitudinal direction, each second wall defines one of the notches in transverse direction.

3. The stylus as claimed in claim 1, wherein the adhesive is 3M2665.

4. The stylus as claimed in claim 2, wherein a latching block protrudes from each first wall, adjacent to the main section, the pointed portion including latching holes, the latching blocks latch with the latching holes.

5. The stylus as claimed in claim 4, wherein the pointed portion includes a tip end and a connecting end opposite to the tip end, the connecting groove is defined in an end wall of the connecting portion, facing the head portion, two opposite sidewalls surround the connecting groove, the latching holes are defined in the two sidewalls.

6. The stylus as claimed in claim 5, wherein the tip end is approximately taper-shaped and made of wear-resistant rubber.

7. A stylus comprising:
a stylus body defining a connecting groove; and
a pointed portion comprising a head portion, the head portion defining cutouts and notches, the connecting groove receiving the head portion;
solvent-type adhesive filling up the cutouts and notches to adhere the head portion to the pointed portion.

8. The stylus as claimed in claim 7, wherein the head portion includes two opposite first walls and two opposite second walls, each first wall defines one of the cutouts longitudinally, each second wall defines one of the notches in width way.

9. The stylus as claimed in claim 7, wherein the adhesive is 3M2665.
